(19) United States
(12) Patent Application Publication
(10) Pub. No.: US 2020/0002462 A1
(43) Pub. Date: Jan. 2, 2020

(54) METHOD FOR MODIFYING AT LEAST PENTAMETHYLENE DIISOCYANATE BY MEANS OF SPIROCYCLIC AMMONIUM SALTS AS CATALYST

(71) Applicant: COVESTRO DEUTSCHLAND AG, Leverkusen (DE)

(72) Inventors: Andreas HECKING, Langenfeld (DE); Frank RICHTER, Leverkusen (DE); Christoph EGGERT, Köln (DE)

(21) Appl. No.: 16/486,872

(22) PCT Filed: Feb. 19, 2018
(86) PCT No.: PCT/EP2018/053986

§ 371 Date: Aug. 19, 2019

(30) Foreign Application Priority Data
Feb. 22, 2017 (EP) 17157484.1

(51) Int. Cl. C08G 18/79; C08G 18/73; C08G 18/20; C08G 18/18; C08G 18/02

(52) U.S. Cl. CPC C08G 18/79; C08G 18/73; C08G 18/02; C08G 18/1875; C08G 18/2054

(57) ABSTRACT

The invention relates to a method for modifying isocyanates, in which at least pentamethylene diisocyanate is oligomerized in the presence of at least one catalyst, the catalyst comprising at least one spirocyclic ammonium salt having a cation of formula I as catalyst for the isocyanate modification,

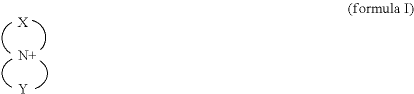

the N-position substituents X and Y representing the same or different, substituted or unsubstituted C₂-C₂₀ alkylene chains optionally interrupted by heteroatoms (0, N, S) and by aromatic rings. The invention further relates to the modified isocyanates obtainable or obtained by means of the method and to the use of such a catalyst to oligomerize at least pentamethylene diisocyanate.

The invention relates to a method for modifying isocyanates, in which method at least pentamethylene diisocyanate is oligomerized in the presence of at least one catalyst, to the use of such a catalyst, and also to the oligo- or polyisocyanates obtainable.

The oligo- or polymerization of isocyanates, especially to form higher molecular weight oligomer mixtures having uretdione (“dimer”), isocyanurate (“trimer”) and/or iminooxadiazinedione structures (“asymmetric trimer”) in the molecular skeleton, collectively called isocyanate modification here, has long been known. The modified polyisocyanates comprising free NCO groups, which optionally may also have been temporarily deactivated with blocking agents, are exceptionally high-quality starting materials for the preparation of a multiplicity of polyurethane plastics and coating compositions.

A series of industrial methods for isocyanate modification have been established in which the isocyanate to be modified, usually a diisocyanate, is generally reacted by addition of catalysts and these are then rendered inactive (deactivated) by suitable measures, when the desired degree of conversion of the isocyanate to be modified has been reached, and the polyisocyanate obtained is generally separated from the unreacted monomer. A summary of these methods from the prior art can be found in H. J. Laas et al., J. Prakt. Chem. 1994, 336, 185 ff.

Useful modification catalysts have been found to be neutral bases and compounds of ionic composition. The latter can usually be used in a very small amount and lead extremely rapidly to the desired result. In the case of the neutral bases, depending on the monomer to be converted and the neutral base used, this is not always true, but it is virtually impossible to infer structure-effect or -activity relationships (cf. Chem. Eur. J. 2009, 15, 5200-5202).

The option of also using tetraorganylammonium or -phosphonium as cation to the anion which is catalytically active toward isocyanates, such as hydroxide, alkanoate, alkoxylate, etc., is common knowledge, although generally not explicitly emphasized as being particularly preferred; cf.: H. J. Laas et al., J. Prakt. Chem. 1994, 336, 185 ff.

Additionally known is the use of fluorides and hydrogenpolyfluorides, the latter being stable adducts of HF with compounds containing fluoride ions, optionally also in the form of their ammonium or phosphonium salts, for the isocyanate modification, from documents including EP 962 455 A1, EP 962 454 A1, EP 896 009 A1, EP 798 299 A1, EP 447 074 A1, EP 379 914 A1, EP 339 396 A1, EP 315 692 A1, EP 295 926 A1 and EP 235 388 A1.

However, the tetraorganylammonium and -phosphonium (hydrogenpoly)fluorides of the prior art, in the performance of the modification reaction, often have the disadvantage that, when they are used, the reaction can sometimes be maintained only with continuous metered addition of catalyst, meaning that the decomposition of the catalyst in the isocyanate medium proceeds unacceptably quickly for technical purposes compared to the modification reaction.

An additional factor is that, when tetraorganylammonium (hydrogen)polyfluorides are used, an atypical reaction profile is sometimes observed, which leads to products having a much lower iminooxadiazinedione group content than in the case of a regular heat production rate profile (cf. EP 962 455 A1). According to the teaching of EP 962 455 A1, this disadvantage was eliminated by the use of phosphonium salts, but the latter—especially at relatively high reaction temperatures—have the unacceptably high tendency to decomposition mentioned further up, and the decomposition products can have an adverse effect on process and product stability.

EP 2 415 795 A1 describes very stable tetraorganylphosphonium (hydrogenpoly)fluorides that do not have these disadvantages, but they are not commercially available and are preparable only with difficulty.

WO 2015/124504 A1 discloses a method for modifying monomeric organic isocyanates, in which method a spirocyclic ammonium salt having a cation of the formula I is used as catalyst,

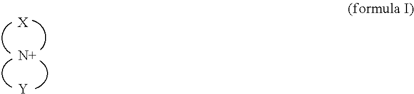

where the nitrogen substituents X and Y are identical or different, substituted or unsubstituted C2-C20-alkylene chains optionally interrupted by heteroatoms (O, N, S) and aromatic rings. A disadvantage of this method is that, with increasing conversion of the monomeric organic isocyanate, the content of desired iminooxadiazinedione groups markedly decreases, which can lead to an increase in viscosity of the products and would thus limit the possible uses. In the listing of the monomeric organic isocyanates that can be used, pentamethylene diisocyanate (also referred to as PDI below) is not disclosed.

The use of PDI for producing PDI polyisocyanates is described in EP 2 684 867 A1, in which a pentamethylene diisocyanate having a total content of 5-400 ppm of compounds of the general formula (1) and (2),

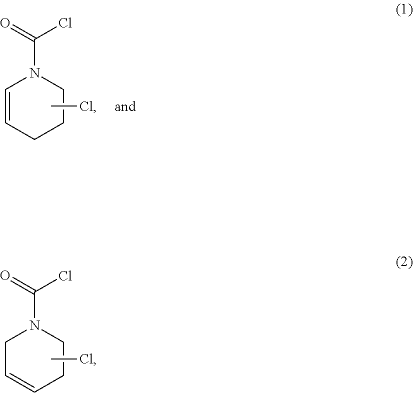

has to be used in order to be able to obtain PDI polyisocyanates that are color-stable on storage. Therefore, PDI appears to impose particular requirements on the product quality. From a technical perspective, this is a major disadvantage and significantly reduces the economic viability, since PDI having a total content of compounds of the general formula (1) and (2) of above 400 ppm or below 5 ppm cannot be used at all, particularly for color-sensitive applications.

It is therefore further desirable to have a method in which firstly the proportion of iminooxadiazinedione groups remains virtually constant even at relatively high conversion such that a high space-time yield can be achieved, and secondly color-stable polyisocyanates can be obtained even when the PDI used has a total content of compounds of the general formula (1) and (2) outside the range disclosed in EP 2 684 867 A1.

The object of the invention therefore was to provide an improved method for isocyanate modification, in which in which firstly the proportion of iminooxadiazinedione groups remains virtually constant even at relatively high conversion such that a high space-time yield can be achieved, and secondly color-stable polyisocyanates can be obtained even when the PDI used has a total content of compounds of the general formula (1) and (2) outside the range disclosed in EP 2 684 867 A1.

This object is achieved by a method for modifying isocyanates, in which method at least pentamethylene diisocyanate is oligomerized in the presence of at least one catalyst, wherein the catalyst comprises at least one spirocyclic ammonium salt having a cation of the formula I as catalysts for the isocyanate modification,

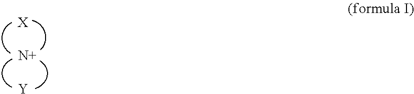

where the nitrogen substituents X and Y are identical or different, substituted or unsubstituted C₂-C₂₀-alkylene chains optionally interrupted by heteroatoms (O, N, S) and aromatic rings.

Surprisingly, it has been shown that the known catalysts produce a constantly high proportion of iminooxadiazinedione groups when using at least pentamethylene diisocyanate as starting compound, which affords advantages, for example, of a lower viscosity. Due to the lower viscosity, the modified pentamethylene diisocyanate-based polyisocyanates according to the invention can be used with more versatility.

In addition, in contrast to the disclosure of EP 2 684 867 A1, it could be shown that, with the method according to the invention, no negative effects exist of the compounds (1) and (2) in concentrations outside the range described in EP 2 684 867 A1 on the color stability.

Compounds of the structure type to be used at least as catalyst are accessible in a simple manner by methods known from the literature (e.g. US 2007/0049750 and literature cited therein), for example by reacting secondary cyclic amines with suitably substituted dihaloalkanes, optionally in the presence of a hydrogen halide scavenger, and subsequent anion exchange.

According to the invention, X and Y in formula I may each independently be optionally substituted alkylene groups, preference being given to C₄-C₆-alkylene chains, especially in both N-centered rings. The C₄-C₆-alkylene chains are preferably of linear structure. These are obtainable in a simple manner, for example, by reaction of optionally C-substituted pyrrolidines, piperidines and azepanes (1H-hexahydroazepines) with 1,4-dihalobutane, 1,5-dihalopentane or 1,6-dihalohexane and the C-substituted derivatives thereof, where halogen is Cl, Br and I, preferably Cl.

In addition, for example, by analogous reaction of optionally C-substituted oxazolidines, isoxazolidines, oxazinanes, morpholines and oxazepanes and the analogs of the aforementioned N—O heterocycles which contain S rather than O, and also imidazolidines, pyrazolidines, piperazines and structurally related compounds, with the abovementioned dihaloalkanes, it is also possible to obtain representatives having C chains interrupted by heteroatoms in one of the X or Y segments of the general formula I. In the case of species containing 2 or more nitrogen atoms, it is additionally possible, by appropriate variation of the reaction conditions, also to produce salts having a doubly or multiply charged cation or, by prior suitable substitution of the nitrogen atom(s), to arrive at singly positively charged cations of the formula I in which one or more exocyclic alkyl substituent(s) is/are present on the trivalent nitrogen atom(s) of the X or Y ring.

Of course, it is also possible through suitable choice of the alkylating agent to introduce a structural variation into the ring segment X or Y; examples include reactions of bis(2-haloethyl) ethers with the abovementioned secondary cyclic amines.

Examples of such syntheses are described, inter alia, in US 2007/0049750 A1, the content of which is hereby fully considered to be incorporated into the present application, especially with regard to paragraphs [0015] to [0039] of this publication.

Anions used in the compounds of the formula I may in principle be any species, especially those which are known to be catalytically active with respect to isocyanates, for example hydroxide, alkanoate, carboxylate, heterocycles having at least one negatively charged nitrogen atom in the ring, such as azolate, imidazolate, triazolate, tetrazolate, fluoride, hydrogendifluoride and higher polyfluorides (adducts of more than one equivalent of HF onto compounds containing fluoride ions), where the fluorides, hydrogendifluorides and higher polyfluorides lead in accordance with the invention to products having a high iminooxadiazinedione group content and are therefore particularly preferred.

The catalysts of the invention can be used individually or in any desired mixtures with one another.

By the modification process of the invention, a variety of high-quality polyisocyanates, which are therefore very valuable for the polyurethane sector, is obtainable in a simple manner. Depending on the starting (di)isocyanate used and the reaction conditions, the method of the invention affords polyisocyanates of what is known as the isocyanate trimer type (i.e. containing isocyanurate and/or iminooxadiazinedione structures) having a low proportion of uretdione groups (“isocyanate dimers”). In the case of rising reaction temperature, the proportion of the latter in the process products generally rises, but this effect is far less marked than when phosphonium salts with identical anion are used.

In the method of the invention, it may further be the case that the oligomerization is conducted in the presence of a solvent and/or additive.

In addition to the use of pentamethylene diisocyanate that is essential to the invention, in order to carry out the method according to the invention it is possible in principle to concomitantly use all known monomeric mono-, di- or polyisocyanates from the prior art, individually or in any desired mixtures with one another. Examples include: hexamethylene diisocyanate (HDI), 2-methylpentane 1,5-diisocyanate, 2,4,4-trimethylhexane 1,6-diisocyanate, 2,2,4-trimethylhexane 1,6-diisocyanate, 4-isocyanatomethyloctane 1,8-diisocyanate, 3(4)-isocyanatomethyl-1-methylcyclohexyl isocyanate (IMCI), isophorone diisocyanate (IPDI), 1,3- and 1,4-bis(isocyanatomethyl)benzene (XDI), 1,3- and 1,4-bis(isocyanatomethyl)cyclohexane (H6XDI), bis(4-isocyanatocyclohexyl)methane (“hydrogenated MDI”), bis(isocyanatomethyl)bicyclo[2.2.1]heptane (NBDI), tolylene 2,4- and 2,6-diisocyanate (TDI), bis(4-isocyanatophenyl)methane (4,4′ MDI), 4-isocyanatophenyl-2-isocyanatophenylmethane (2,4′MDI) and polycyclic products obtainable by formaldehyde-aniline polycondensation and subsequent conversion of the resulting (poly)amines to the corresponding (poly)isocyanates (polymer MDI).

In the case of optional concomitant use, preference is given to monomeric aliphatic diisocyanates, i.e. diisocyanates in which both NCO groups are bonded to an sp³-hybridized carbon atom. Particular preference is given to hexamethylene diisocyanate (HDI), 2-methylpentane 1,5-diisocyanate, 2,4,4-trimethylhexane 1,6-diisocyanate, 2,2,4-trimethylhexane 1,6-diisocyanate, 4-isocyanatomethyloctane 1,8-diisocyanate, 3(4)-isocyanatomethyl-1-methylcyclohexyl isocyanate (IMCI), isophorone diisocyanate (IPDI), 1,3- and 1,4-bis(isocyanatomethyl)benzene (XDI) and 1,3- and 1,4-bis(isocyanatomethyl)cyclohexane (H6XDI).

If the isocyanates different from PDI, mentioned in the two preceding paragraphs, are intended to be concomitantly used, these are preferably used in amounts of up to 80% by weight, preferably up to 50% by weight, particularly preferably up to 20% by weight, based on the total weight of the PDI used and the isocyanates concomitantly used.

Therefore, a preferred embodiment of the method according to the invention is a method for modifying isocyanates, in which method pentamethylene diisocyanate and at least one of the aforementioned isocyanates are oligomerized in the presence of at least one catalyst, wherein the catalyst comprises at least one spirocyclic ammonium salt having a cation of the formula I as catalysts for the isocyanate modification,

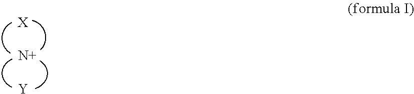

where the nitrogen substituents X and Y are identical or different, substituted or unsubstituted C₂-C₂₀-alkylene chains optionally interrupted by heteroatoms (O, N, S) and aromatic rings, and in which PDI is used to an extent of at least 20% by weight, preferably to an extent of at least 50% by weight and particularly preferably to an extent of at least 80% by weight, based on the total weight of PDI used and the isocyanates concomitantly used.

However, particular preference is given to using only pentamethylene diisocyanate as sole monomeric isocyanate for the modification. This results in the advantage that the reduction of the proportion of iminooxadiazinedione groups at a high degree of conversion is even further avoided. The modification of pentamethylene diisocyanate is considered as the oligo- or polymerization of PDI, especially to form higher molecular weight oligomer mixtures having uretdione (“dimer”), isocyanurate (“trimer”) and/or iminooxadiazinedione structures (“asymmetric trimer”) in the molecular skeleton, collectively also called PDI modification here.

For the present invention, it is possible to use PDI and the aforementioned isocyanates to be optionally concomitantly used, irrespective of the methods by which they have been prepared, i.e. whether they have been produced, for example, with or without use of phosgene.

The method according to the invention, with respect to the quality of the at least and preferably exclusively pentamethylene diisocyanate to be used, is largely independent of the content of compounds of the general formula (1) and (2).

The amount of the catalyst to be used in the method according to the invention is guided primarily by the desired reaction rate and is preferably 0.001 to 5 mol %, based on the sum total of the molar amounts of the PDI used and of the aforementioned isocyanates to be optionally concomitantly used and of the catalyst. Preference is further given to using 0.002 to 2 mol % of catalyst.

In the method according to the invention, the catalyst may be used undiluted or dissolved in solvents. Useful solvents are all compounds which do not react with the catalyst and are capable of dissolving it to a sufficient degree, for example aliphatic or aromatic hydrocarbons, alcohols, ketones, esters and ethers. Preference is given to using alcohols.

The method according to the invention can be conducted in the temperature range from 0° C. to +250° C., preferably 20 to 180° C., particularly preferably 40 to 150° C., and can be stopped at any degrees of conversion, preferably after 5 to 50%, particularly preferably 5 to 40%, especially preferably 30 to 40%, of the total amount of isocyanate groups of the PDI used and of the isocyanates to be optionally concomitantly used have been reacted.

The degree of conversion is understood to mean the percentage of the isocyanate groups originally present in the starting mixture which is consumed during the reaction according to the invention. The degree of conversion in percent can be calculated according to the following formula:

Degree of conversion=(NCO Start−NCO End)/NCO Start×100

The content of isocyanate groups can be determined by titration in accordance with DIN EN ISO 11 909:2007-05 for example.

Catalyst deactivation can be accomplished in principle by employing a whole series of previously described prior art methods, for example the addition of (sub- or super-)stoichiometric amounts of strong acids or acid derivatives (e.g. benzoyl chloride, acidic esters of phosphorus- or sulfur-containing acids, these acids themselves, etc., but not HF), adsorptive binding of the catalyst and subsequent removal by filtration, and other methods known to those skilled in the art.

By contrast with catalysis by ammonium salts in which the charge-bearing nitrogen atom is not part of a spirocyclic ring system, when the catalysts of the invention having fluoride or oligo/polyfluoride anions are used, there is surprisingly no observation of any anomalies at all in the heat production rate, and a homogeneous reaction profile is always observed, which leads to high-quality products having an iminooxadiazinedione group content optimal for the particular reaction conditions.

It is quite generally the case that the catalysts of the invention, irrespective of the anion which is responsible for the catalytic activity and selectivity, are much more stable in the isocyanate medium than the prior art derivatives known from the literature. In combination with the use of PDI that is essential to the invention, surprisingly constantly high proportions of iminooxadiazinedione groups can be achieved even at higher degrees of conversion than when only isocyanates different from PDI are oligomerized.

In a particular continuously operating embodiment of the method according to the invention, the oligomerization can be undertaken in a tubular reactor.

The products or product mixtures obtainable by the method according to the invention are consequently versatile starting materials for production of optionally foamed plastic(s) and of paints, coating compositions, adhesives and additives. They are especially suitable for production of optionally water-dispersible one- and two-pack polyurethane paints, optionally in NCO-blocked form, because of their reduced solution and melt viscosity in comparison to (predominantly) isocyanurate polyisocyanate-based products with an otherwise equivalent or improved profile of properties. Thus, the PDI-based process products according to the invention, even in high dilution in paint solvents, are more stable to the occurrence of flocculation or turbidity than corresponding prior art products.

The present invention therefore further relates to a modified isocyanate preparable or prepared by the method according to the invention.

The process products according to the invention can be used pure or in conjunction with other prior art isocyanate derivatives, such as polyisocyanates containing uretdione, biuret, allophanate, isocyanurate and/or urethane groups, wherein the free NCO groups have optionally been deactivated with blocking agents.

The present invention further provides for the use of a spirocyclic ammonium salt having a cation of the formula I, (N

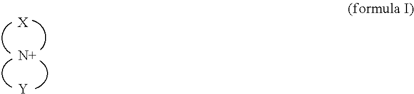

where the nitrogen substituents X and Y are identical or different, substituted or unsubstituted C₂-C₂₀-alkylene chains optionally interrupted by heteroatoms (O, N, S) and aromatic rings, as catalysts for the oligomerization of at least pentamethylene diisocyanate. Also in the use according to the invention, it is preferred when only pentamethylene diisocyanate is used for the oligomerization since this is also associated with the advantages described above.

The present invention is more particularly elucidated hereinafter with reference to examples and comparative examples, but without restricting it thereto.

### EXAMPLES

All percentages and ppm data, unless noted otherwise, are based on weight.

All reactions were carried out under a nitrogen atmosphere.

The NCO contents were determined by titrimetry according to DIN EN ISO 11909:2007-05.

The HC/AC contents were determined in accordance with ISO 15028:2014.

The dynamic viscosities were determined at 23° C. using the viscometer Physica MCR 51 from Anton Parr in accordance with DIN EN ISO 3219:1994-10. By measurements at different shear rates, it was ensured that the flow behaviour of the polyisocyanate mixtures described according to the invention and also that of the comparative products corresponds to that of ideal Newtonian fluids. The indication of the shear rate can therefore be omitted.

The residual monomer contents were determined by gas chromatography using an internal standard in accordance with DIN EN ISO 10283:2007-11.

Mol % figures were determined by NMR spectroscopy and always relate, unless specified otherwise, to the sum total of the NCO conversion products. The measurements were effected on the Bruker DRX 700 instrument on ca. 1% (¹H NMR) or ca. 50% (¹³C NMR) samples in dry C₆D₆ at a measurement frequency of 700 MHz (¹H NMR) or 176 MHz (¹³C NMR). The C₆D₅H present in the solvent was used as reference signal for the ppm scale: ¹H NMR chemical shift 7.15 ppm, ¹³C NMR chemical shift 128.02 ppm. Data for the chemical shift of the compounds in question were taken from the literature (cf. D. Wendisch, H. Reiff and D. Dieterich, Die Angewandte Makromolekulare Chemie 141, 1986, 173-183 and literature cited therein and EP-A 896 009).

The diisocyanates used are products of Covestro Deutschland AG, D-51365 Leverkusen; all other commercially available chemicals were sourced from Aldrich, D-82018 Taufkirchen.

The preparation of a catalyst to be used according to the invention is described in Example 1.

6-Chloro-3,4-dihydropyridine-1(2H)-carbonyl chloride was obtained according to WO 2012/041789, Example 3.2 on page 83, line 20 to page 84, line 5. As a deviation from the method described therein, 6-chloro-3,4-dihydropyridine-1(2H)-carbonyl chloride was obtained after repeated rectification under reduced pressure at ca. 99% (GC, area percent, not normalized) purity as a pale yellowish liquid (bp 66° C. at 0.3 mbar, identity proved by ¹H- and ¹³C-NMR).

### Example 1 Catalyst Preparation: 5-azoniaspiro[4.5]decanium Hydrogendifluoride

To a mixture pre-heated to 100° C. of 13.1 g (0.15 mol) of piperidine and 20 g (0.18 mol) of 50% aqueous potassium hydroxide solution were added dropwise 20 g (0.16 mol) of 1,4-dichlorobutane such that the internal temperature did not exceed 110° C. After addition was complete, the mixture was stirred for a further four hours at 100° C. and then cooled to room temperature.

To the resulting reaction mixture were added at room temperature with stirring 360 g of a ca. 5% methanolic potassium fluoride solution. The mixture was stirred for a further 8 hours at room temperature, filtered, largely freed of methanol under reduced pressure, taken up in ca. 200 g of 2-ethylhexanol, filtered again, 3 g of anhydrous hydrofluoric acid were added and the mixture was stirred for a further 2 hours at room temperature. The mixture was then heated to reflux under reduced pressure with batchwise distillate removal as long as gas chromatographically pure 2-ethylhexanol distilled off. The catalyst solution thus obtained (ca. 125 g, ca. 20% of 5-azoniaspiro[4.5]decanium hydrogendifluoride) was used in the following experiments.

### Example 2 (Comparative Examples)

1055 g of HDI were initially charged, and freed from dissolved gases by stirring for one hour under vacuum (<1 mbar), in a jacketed vessel with flat-ground joints which was maintained at a temperature of 60° C. by means of an external circulation and which was fitted with a stirrer, a reflux condenser connected to an inert gas unit (nitrogen/vacuum) and thermometer. After venting with nitrogen, the amount of catalyst specified in Table 1 was metered in in portions in such a way that the exothermicity of the reaction did not exceed 2-3° C. After the NCO content had fallen to

a) ca. 45+/−0.5%

b) ca. 30+/−1%

the catalyst was deactivated by adding to the catalyst an equimolar amount of dodecylbenzenesulfonic acid, 70% in 2-PrOH, stirring at reaction temperature for a further 30 min and then the mixture was worked-up.

The work-up was carried out by vacuum distillation in a thin-film evaporator of the flash evaporator (FE) type with a preevaporator (PE) connected upstream (distillation data: pressure: 0.1+/−0.05 mbar, PE temperature: 120° C., ME temp.: 140° C.), with separation of unreacted monomer as distillate and the low-monomer polyisocyanate resin as bottom product (starting run). The polyisocyanate resin was separated, filtered and the distillate was collected in a second flange stirring apparatus of identical construction to the first, and made up to the starting amount (1055 g) with freshly degassed HDI. Thereafter, the mixture was treated again with catalyst and the procedure as described at the outset was followed. This procedure was repeated several times (experiments a1, a2, a3 . . . or b1, b2, b3 . . . etc.). The results can be found in Table 1.

TABLE 1

| | | Resin | | Viscosity | Color | | |
|---|---|---|---|---|---|---|---|
| Example | Catalyst | amount | | [mPas/ | number | fr. HDI | Iminooxadiazinediones |
| no. | sol. [g] | [g] | NCO [%] | 23° C.] | (APHA) | [%] | [mol-%]¹⁾ |
| 2a-1 | 0.72 | 169 | 23.7 | 688 | 66 | 0.11 | 54 |
| 2a-2 | 0.76 | 195 | 23.6 | 795 | 51 | 0.08 | 51 |
| 2a-3 | 0.70 | 178 | 23.7 | 652 | 40 | 0.07 | 55 |
| 2a-4 | 0.55 | 182 | 23.6 | 741 | 42 | 0.08 | 53 |
| 2a-5 | 0.54 | 177 | 23.9 | 710 | 45 | 0.05 | 54 |
| 2a-6 | 0.55 | 175 | 23.7 | 724 | 35 | 0.05 | 54 |
| 2b-1 | 1.35 | 633 | 19.4 | 13 200 | 60 | 0.08 | 32 |
| 2b-2 | 1.23 | 620 | 19.5 | 12 900 | 32 | 0.04 | 35 |
| 2b-3 | 1.31 | 640 | 19.3 | 13 400 | 47 | 0.05 | 34 |
| 2b-4 | 1.28 | 645 | 19.3 | 13 200 | 50 | 0.06 | 35 |
| 2b-5 | 1.30 | 642 | 19.3 | 13 250 | 44 | 0.06 | 33 |
| 2b-6 | 1.15 | 633 | 19.5 | 12 950 | 46 | 0.04 | 32 |

¹⁾Iminooxadiazinedione group content relatively in total trimers (iminooxadiazinediones and isocyanurates, determined by NMR)

The resins obtained were, without exception, light-colored clear viscous liquids with no perceptible amine odor. The products produced with high conversion (Example Series 2b) have without exception a significantly lower content of iminooxadiazinedione groups than the products produced with lower conversion of Example Series 2a.

### Example 3 (Inventive)

In an apparatus as described in Example 2, 1000 g of PDI were initially charged, of which the content of 6-chloro-3,4-dihydropyridine-1(2H)-carbonyl chloride had been adjusted to 190 ppm by addition of the pure substance specified at the start, and treated analogously to the procedure described therein, with the difference that a molar amount of deactivator was metered in equivalent to the amount of catalyst used after the NCO content had fallen to
a) ca. 50+/−0.5%
b) ca. 35+/−1%.

The work-up and continuous recycling was carried out in a manner analogous to that described in Example 2 using the PDI quality described above. The results can be found in Table 2.

TABLE 2

| | | Resin | | Viscosity | Color | | |
|---|---|---|---|---|---|---|---|
| Example | Catalyst | amount | | [mPas/ | number | fr. PDI | Iminooxadiazinediones |
| no. | sol. [g] | [g] | NCO [%] | 23° C.] | (APHA) | [%] | [mol-%]¹⁾ |
| 3a-1 | 1.20 | 110 | 25.8 | 922 | 54 | 0.16 | 49 |
| 3a-2 | 0.95 | 115 | 25.7 | 890 | 35 | 0.11 | 51 |
| 3a-3 | 0.88 | 117 | 25.7 | 900 | 32 | 0.09 | 52 |
| 3a-4 | 0.85 | 120 | 25.6 | 910 | 30 | 0.07 | 53 |
| 3a-5 | 0.90 | 110 | 25.9 | 900 | 25 | 0.06 | 55 |
| 3a-6 | 0.85 | 115 | 25.7 | 890 | 28 | 0.07 | 55 |
| 3b-1 | 3.02 | 540 | 22.0 | 6900 | 52 | 0.04 | 47 |
| 3b-2 | 2.95 | 550 | 21.9 | 7140 | 42 | 0.03 | 48 |
| 3b-3 | 3.10 | 550 | 22.1 | 6950 | 39 | 0.05 | 48 |
| 3b-4 | 3.21 | 535 | 21.9 | 6830 | 40 | 0.04 | 45 |
| 36-5 | 3.15 | 560 | 22.0 | 6720 | 45 | 0.03 | 49 |
| 3b-6 | 3.10 | 525 | 22.2 | 7130 | 38 | 0.03 | 48 |

¹⁾Iminooxadiazinedione group content relatively in total trimers (iminooxadiazinediones and isocyanurates, determined by NMR)

The resins obtained were, without exception, light-colored clear viscous liquids with no perceptible amine odor. The products produced with high conversion (Example Series 3b) have a virtually constant content of iminooxadiazinedione groups compared to the products produced with lower conversion of Example Series 3a.

### Example 4 (Inventive)

This was conducted analogously to Example Series 3b with the difference that the reaction in experiments 4-1 to 4-4 was conducted at 80-85° C. and the latter two experiments at 100-105° C. and 1000 g of PDI was used, of which the content of 6-chloro-3,4-dihydropyridine-1(2H)-carbonyl chloride had been adjusted to 540 ppm by addition of the pure substance specified at the start. The results can be found in Table 3.

TABLE 3

| | | Resin | | Viscosity | Color | | |
|---|---|---|---|---|---|---|---|
| Example | Catalyst | amount | | [mPas/ | number | fr. PDI | Iminooxadiazinediones |
| no. | sol. [g] | [g] | NCO [%] | 23° C.] | (APHA) | [%] | [mol-%]¹⁾ |
| 4-1 | 2.75 | 500 | 21.8 | 5200 | 75 | 0.12 | 38 |
| 4-2 | 1.65 | 550 | 21.3 | 5900 | 45 | 0.14 | 30 |
| 4-3 | 1.63 | 540 | 22.0 | 6200 | 48 | 0.13 | 29 |
| 4-4 | 1.63 | 550 | 21.7 | 7500 | 58 | 0.05 | 31 |
| 4-5 | 1.96 | 500 | 21.0 | 8000 | 72 | 0.06 | 16 |
| 4-6 | 2.00 | 550 | 21.4 | 6560 | 62 | 0.05 | 15 |

¹⁾Iminooxadiazinedione group content relatively in total trimers (iminooxadiazinediones and isocyanurates, determined by NMR)

The resins obtained were, without exception, light-colored clear viscous liquids with no perceptible amine odor. The resins produced at higher reaction temperature (Examples 4-5 and 4-6), at only marginally worse color number, have an, as expected, lower content of iminooxadiazinedione groups than the products produced at lower reaction temperature (4-1 to 4-4).

### Example 5 (Inventive)

This was conducted analogously to Example Series 4 with the difference that the reactions were conducted at 70-73° C., the catalyst was used as a ca. 1% solution in 2-ethylhexanol, 1000 g of PDI was used, of which the HC/AC content was below the limit of detection (<5 ppm) and in which no 6-chloro-3,4-dihydropyridine-1(2H)-carbonyl chloride was detectable by gas chromatography and toluenesulfonic acid monohydrate, 50% dissolved in iPrOH, was used as deactivator.

The results can be found in Table 4.

TABLE 4

| | | Resin | | Viscosity | Color | | |
|---|---|---|---|---|---|---|---|
| Example | Catalyst | amount | | [mPas/ | number | fr. PDI | Iminooxadiazinediones |
| no. | sol. [g] | [g] | NCO [%] | 23° C.] | (APHA) | [%] | [mol-%]¹⁾ |
| 5-1 | 4.78 | 540 | 22.5 | 9340 | 55 | 0.07 | 20 |
| 5-2 | 4.86 | 530 | 21.7 | 9000 | 20 | 0.08 | 14 |
| 5-3 | 4.86 | 520 | 22.3 | 9630 | 54 | 0.05 | 19 |
| 5-4 | 4.39 | 550 | 21.7 | 9800 | 39 | 0.05 | 16 |
| 5-5 | 4.76 | 520 | 22.3 | 9400 | 44 | 0.14 | 16 |
| 5-6 | 4.80 | 520 | 22.0 | 9480 | 38 | 0.11 | 14 |

¹⁾Iminooxadiazinedione group content relatively in total trimers (iminooxadiazinediones and isocyanurates, determined by NMR)

The resins obtained were, without exception, light-colored clear viscous liquids with no perceptible amine odor.

### Example 6 (Inventive)

In an apparatus as described in Example 2, a mixture of 200 g of PDI, of which the content of 6-chloro-3,4-dihydropyridine-1(2H)-carbonyl chloride had been adjusted to 190 ppm by addition of the pure substance specified at the start, and 800 g of HDI were initially charged and treated analogously to the procedure described in Example 2, with the difference that a molar amount of deactivator was metered in equivalent to the amount of catalyst used after the NCO content had fallen to
a) ca. 47.0+/−0.5%
b) ca. 33.0+/−1%.

The work-up and continuous recycling was carried out in a manner analogous to that described in Example 2 using the PDI/HDI mixture described above.

The results can be found in Table 5.

TABLE 5

| Example | Catalyst sol. | Resin | | Viscosity | fr. PDI | fr. HDI | Iminooxadiazinediones |
|---|---|---|---|---|---|---|---|
| no. | [g] | amount [g] | NCO [%] | [mPas/23° C.] | [%] | [%] | [mol-%]¹⁾ |
| 6a-1 | 1.18 | 160 | 23.8 | 1100 | 0.03 | 0.04 | 43 |
| 6a-2 | 1.29 | 180 | 23.8 | 850 | 0.05 | 0.10 | 52 |
| 6a-3 | 1.49 | 180 | 23.7 | 770 | 0.09 | 0.10 | 52 |
| 6b-1 | 1.92 | 590 | 20.3 | 7700 | 0.05 | 0.06 | 50 |
| 6b-2 | 1.92 | 620 | 19.4 | 11 800 | 0.05 | 0.13 | 48 |
| 6b-3 | 2.01 | 610 | 20.2 | 11 200 | 0.09 | 0.04 | 47 |

¹⁾Iminooxadiazinedione group content relatively in total trimers (iminooxadiazinediones and isocyanurates, determined by NMR)

The products produced in Example Series 6b with high conversion are light-colored, clear viscous liquids with APHA color numbers of 40 and without perceptible amine odor and also have a high content of iminooxadiazinedione groups compared to the products of Example Series 6a produced with lower conversion, which is not the case with the exclusive use of HDI (Comparative Examples 2b).

Measurement of the Storage Stability

All products of Examples 3 to 6 produced by the method according to the invention were stored at 50° C. in sealed aluminum containers and were tested with respect to their color development at regular intervals over a period of 6 months. In no case could a significant increase of the Hazen color number be observed and sometimes even a significant lightening of up to 30 APHA occurred.

1: A method for modifying isocyanates, in which method at least pentamethylene diisocyanate is oligomerized in the presence of at least one catalyst, wherein
the catalyst comprises at least one spirocyclic ammonium salt having a cation of the formula I as catalysts for the isocyanate modification, 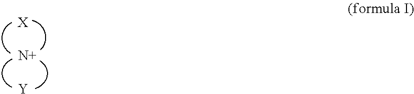
where the nitrogen substituents X and Y are identical or different, substituted or unsubstituted C₂-C₂₀-alkylene chains optionally interrupted by heteroatoms (O, N, S) and aromatic rings.

2: The method as claimed in claim 1, characterized in that X and/or Y are each independently optionally substituted C₄-C₆-alkylene chains and are especially of linear structure.

3: The method as claimed in claim 1, characterized in that the anion of the spirocyclic ammonium salt is selected from hydroxide, alkanoate, carboxylate, heterocycles having at least one negatively charged nitrogen atom in the ring, especially azolate, imidazolate, triazolate or tetrazolate, fluoride, hydrogendifluoride and mixtures of these.

4: The method as claimed in claim 1, characterized in that the oligomerization is conducted in the presence of a solvent and/or additive.

5: The method as claimed in claim 1, characterized in that, in addition to pentamethylene diisocyanate, at least one monomeric organic isocyanate is also used selected from aliphatic diisocyanates, especially from hexamethylene diisocyanate (HDI), 2-methylpentane 1,5-diisocyanate, 2,4,4-trimethylhexane 1,6-diisocyanate, 2,2,4-trimethylhexane 1,6-diisocyanate, 4-isocyanatomethyloctane 1,8-diisocyanate, 3(4)-isocyanatomethyl-1-methylcyclohexyl isocyanate (IMCI), isophorone diisocyanate (IPDI), 1,3- and 1,4-bis(isocyanatomethyl)benzene (XDI), 1,3- and 1,4-bis(isocyanatomethyl)cyclohexane (H6XDI) and mixtures of these.

6: The method as claimed in claim 1, characterized in that only pentamethylene diisocyanate is used as isocyanate for the oligomerization.

7: The method as claimed in claim 1, characterized in that the catalyst of the formula I is used in an amount of 0.001 to 5 mol %, based on the sum total of the molar amounts of the PDI used and of the aforementioned isocyanates to be optionally concomitantly used, and of the catalyst, preferably 0.002 to 2 mol % of catalyst.

8: The method as claimed in claim 1, characterized in that the method is conducted in the temperature range from 0° C. to +250° C., preferably 20 to 180° C., particularly preferably 40 to 150° C.

9: The method as claimed in claim 1, characterized in that the oligomerization is stopped after 5 to 50%, preferably 5 to 40%, particularly preferably 30 to 40%, of the total amount of isocyanate groups of the PDI used and of the isocyanates to be optionally concomitantly used have reacted.

10: The method as claimed in claim 9, characterized in that the oligomerization is stopped by deactivating the catalyst, especially by addition of an acid or an acid derivative such as benzoyl chloride, an acidic ester of phosphorus- or sulfur-containing acids, these acids themselves, adsorptive binding of the catalyst and subsequent removal by filtration or combinations thereof.

11: The method as claimed in claim 9, characterized in that unreacted monomeric organic isocyanate is separated from the reaction mixture.

12: A modified isocyanate preparable or prepared according to a method as claimed in claim 1.

13: The use of a spirocyclic ammonium salt having a cation of the formula I, 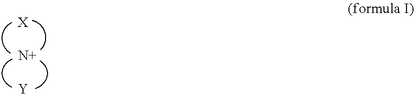
where the nitrogen substituents X and Y are identical or different, substituted or unsubstituted C₂-C₂₀-alkylene chains optionally interrupted by heteroatoms (O, N, S) and aromatic rings, as catalysts for the oligomerization of at least pentamethylene diisocyanate.

14: The use as claimed in claim 13, characterized in that only pentamethylene diisocyanate is used as isocyanate for the oligomerization.
